(19) United States
(12) Patent Application Publication
(10) Pub. No.: US 2008/0146108 A1
(43) Pub. Date: Jun. 19, 2008

(54) Coated fabrics and laminates suitable for rigid armor applications and processes for making same

(76) Inventors: James Neal Singletary, Midlothian, VA (US); Dariusz Wlodzimierz Kawka, Midlothian, VA (US); James Carson Swann, Chester, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/640,694

(22) Filed: Dec. 18, 2006

(51) Int. Cl. B32B 27/12; B28B 1/00

(52) U.S. Cl. 442/135; 264/640

(57) ABSTRACT

This invention relates to a coated fabric and a method of making the same, and laminates and articles comprising the coated fabric. The fabric comprises a woven substrate having fiber volume fraction of at least 70 percent and non-meltable, rigid rod, high strength filaments having angular cross sections created by densifying the woven substrate. The coated fabrics and laminates are especially useful in rigid armor applications.

### BACKGROUND OF THE INVENTION

1. Field of the Invention

This invention relates to a coated fabric and a method of making the same, and laminates and articles comprising the coated fabric. The fabric comprises a woven substrate having a fiber volume fraction of at least 70 percent and non-meltable, rigid rod, high strength filaments having angular cross sections created by densifying the woven substrate. The coated fabrics and laminates are especially useful in rigid armor applications.

2. Description of Related Art

Woven fabrics used in rigid ballistic articles typically have a 70% fiber volume fraction or less; that is, they are at least 30% by volume air. The theoretical maximum packing density of uniaxially oriented, equal sized, circular cylinders (which approximate most high strength fibers) is about 78% for square packing. Since woven fabrics are oriented in multiple directions with crossovers, and necessarily have some crimp, the actual fiber volume fraction in woven fabric reinforcement is much lower.

Fabric density can be calculated as fabric basis weight divided by fabric thickness. The actual fiber density is readily available from fiber manufacturers, and therefore the fiber volume fraction in a fabric is found by dividing fabric density by fiber density. Using specified nominal basis weights, thicknesses, and fiber manufacturers' data on fiber density, typical ballistic fabrics have a fiber volume fraction of less than 65%, and most have a volume fraction of less than 55%.

It is known in the art that the ballistic resistance of fiber-reinforced plastic armor tends to decrease with decreasing yarn tensile strength. Therefore manufacturers have taken steps to avoid deforming or degrading the filaments of non-meltable, rigid rod polymers during the manufacture and handling of multifilament yarns, fabric, and/or ballistic articles. For example, it is well known in the art that in the manufacture of ballistic fabrics and articles from such rigid rod fibers, care should be taken to not damage the individual filaments during weaving and subsequent fabric handling and processing. It is recognized that any damage to the filaments reduces fiber strength and elongation to break, both of which have been long associated in the art with reduced fabric ballistic resistance.

It is also known that tensile strength of high strength rigid rod fibers decreases with increasing exposure to higher temperatures. For example, the tensile strength of para-aramid fiber can be reduced upon exposure to temperatures above 250° C. Therefore armor manufacturers generally avoid subjecting ballistic fabrics to any treatment that either excessively heats or generates frictional heat in the fabrics.

U.S. Pat. Nos. 5,958,804 and 5,788,907 to Brown et al. disclose fabrics having improved ballistic performance, the fabrics including a network of consolidated multifilament yarns formed of high strength filaments. At least a portion of the high strength filaments of the yarns are temporarily locked together to provide a substantially stable, flattened cross section configuration to the yarns. As disclosed in the patent, the pressure and temperature applied to the fabric during consolidation is not so great as to substantially modify the fibrous nature of the yarns. In other words, the yarns are flattened but the individual filaments are not appreciably changed.

U.S. Pat. No. 5,660,913 to Coppage discloses a composite fabric of a first non-woven fabric outer layer, a woven fabric middle layer, and second non-woven fabric inner layer. The non-woven layers are made up of a multiplicity of individual non-woven sublayers and each of these sub-layers is conventionally made up of a resin bonded, substantially unidirectional non-woven ballistic fibers. The woven fabric middle layer is made up of a multiplicity of woven individual sub-layers of conventional ballistic fibers (yarns). The sub-layers are not quilted or otherwise jointed to each other throughout their entire area, but can stabilized by tacking them together at various locations. A substantial number of the sub-plies are calendered to spread out the individual fibers of the woven yarns to partially cover gaps in the weave and cover a larger area. Therefore Coppage seeks to simply rearrange the individual filaments by sliding them essentially laterally into voids in the fabric.

Any improvement in the ballistic performance of rigid armor articles has the potential to save lives and is therefore desired.

### SUMMARY OF THE INVENTION

This invention relates to a coated fabric suitable for reinforcing rigid articles to protect against ballistic impact, and laminates and articles comprising the coated fabric. The coated fabric comprises a woven substrate having a fiber volume fraction of at least 70%, the fiber being present as densified filament bundles comprising non-meltable, rigid-rod filaments, the filament bundles having a tenacity of at least 15 grams per denier (13.6 grams per dtex), the filaments having angular cross sections, and a coating on the woven substrate present in an amount not more than 25% by weight of the total weight of the woven substrate and coating combined.

This invention also relates to a process of making a coated fabric comprising the steps of
(a) compressing a woven substrate containing bundles of round, non-meltable, rigid-rod filaments with heat and pressure to flatten the bundles of filaments, the filament bundles having a tenacity of at least 15 grams per denier (13.6 grams per dtex);
(b) continuing to compress the substrate to further deform the round cross sections of the filaments to angular cross sections and form a densified substrate having a fiber volume fraction of at least 70%; and
(c) contacting a surface of the densified substrate with a coating material.

### BRIEF DESCRIPTION OF DRAWINGS

FIG. 1 is one representation of a coated fabric

FIG. 1a is a cutout showing the angular cross sections of the filaments in the woven substrate.

FIG. 2 is one representation of a laminate comprising 5 layers of coated fabric.

FIGS. 3a and 3b are copies of digital photos comparing cross sections of an undensified woven substrate having filaments with round cross sections with a densified woven substrate having filaments with angular cross sections.

FIG. 4 is a graph showing the effect of fiber volume fraction on ballistic performance.

### DETAILED DESCRIPTION OF THE INVENTION

The present invention is premised on a discovery that coated fabrics containing a woven substrate of non-meltable, rigid rod filaments that has been compressed beyond the elastic limit of the filaments, that is, until permanent defects have been formed in the filaments, unexpectedly leads to a dramatic increase in ballistic resistance when used in armor.

Without being constrained by theory, it is believed that the present invention has increased ballistic resistance because the surface area of adhesion between the woven substrate and the coating has been reduced. This promotes adhesive failure delamination during a ballistic event, increasing laminate ballistic resistance more than is likely sacrificed by the mechanical/thermal damage to the filaments during compression.

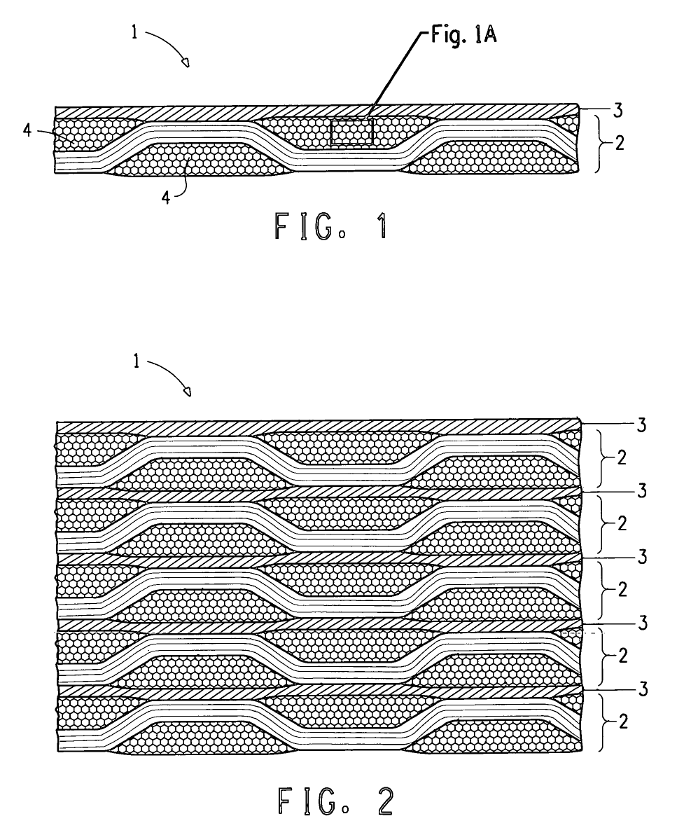

This invention relates to a coated fabric for reinforcing rigid articles, the fabric being comprised of a densified woven substrate having non-meltable rigid rod filaments with angular cross sections and a coating on the substrate in an amount of not more tha 25 weight percent of the total weight of the woven substrate and coating combined. FIG. 1 is an end view illustration of coated fabric 1 having a densified woven substrate 2 and a surface coating 3 of resin. The densified woven substrate 2 is comprised of flatten bundles 4 of filaments; shown are the warp bundles. The filaments 5 in the bundles have angular cross sections and are shown magnified in FIG. 1a as a cutout. The filaments are not round but have one or more sharp corners, edges, or features along their length.

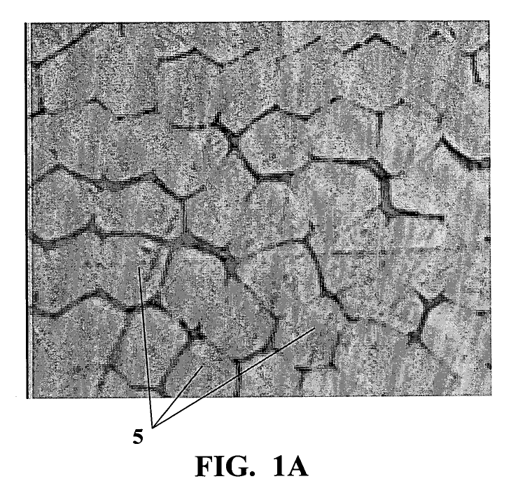

The invention also relates to a laminate comprising the coated fabric; FIG. 2 is an illustration of a laminate 6 comprised of 5 layers of coated fabric 1. The coated fabrics are laid up with the coatings alternating; the coating 3 on the woven substrate 2 provides the adhesion between the coated fabrics so that no additional resin is required to laminate the coated fabrics together. While 5 layers are shown in this figure any number of layers could be used in the laminate.

The invention includes a woven substrate having a fiber volume fraction of at least 70%, the fiber being present as densified filament bundles comprising non-meltable, rigid-rod filaments, the filament bundles having a tenacity of at least 15 grams per denier (13.6 grams per dtex), the filaments having angular cross sections. Herein, the term “filament” is used interchangeably with the term “fiber”. By “woven substrate” it is meant a self-sustaining fibrous architecture that includes woven or knitted structures. By woven is meant any fabric weave, such as, plain weave, crowfoot weave, basket weave, satin weave, twill weave, and the like. Plain weave is the most common. When woven, the cover factor or tightness of the weave is not believed to be particularly important, except that the woven substrate shouldn't be woven so tightly as to damage of yarn fibers from the rigors of weavings; and the woven substrate shouldn't be woven so loosely that the woven substrate becomes too difficult to handle. In some preferred embodiments, knitted structures include multiaxially reinforced knits. In some embodiments, the areal density of the woven substrate is 67 to 670 g/m². In some preferred embodiments, the areal density of the woven substrate is 200 to 450 g/m².

The woven substrate is made from bundles of filaments. In many embodiments a “bundle of filaments” is a continuous multifilament yarn. For purposes herein, the term “filament” is defined as a relatively flexible, macroscopically homogeneous body having a high ratio of length to width across its cross-sectional area perpendicular to its length. In some embodiments, the filaments have a linear density of about 0.5 dtex to about 4 dtex, and in some preferred embodiments the filament linear density is about 0.7 dtex to about 2.0 dtex. The filament cross section are generally round or substantially round prior to compression of the woven substrate. After compression, a majority of the round cross section filaments have angular cross sections; that is, they have sharp acute angles formed by exceeding the elastic limit of the filaments. In some preferred embodiments 70 percent or greater of the filaments have an angular cross section. The acuteness of the angular cross sections can be more pronounced at points in the woven substrate where the warp yarns cross over the fill yarns, also called “cross over points”. However, throughout the warp and fill yarns, after compression to achieve a 70% fiber volume, a majority of the filaments have an angular cross section as identified by optical microscopy.

The filament bundles have a tenacity of at least 15 grams per denier (13.6 grams per dtex) to 55 grams per dtex. In some preferred embodiments the tenacity is at least 20 grams per denier and more preferably 22 grams per denier. In some embodiments, the yarns have a linear density of about 100 dtex to about 3300 dtex, and in some embodiments the linear density is of about 200 dtex to about 1700 dtex. In some preferred embodiments the linear density is about 200 dtex to about 660 dtex. In some embodiments the yarns exhibit an elongation at break of at least 1.5%, and preferably about 2.0% to about 10%. In some embodiments the yarns exhibit a Young's modulus, or modulus of elasticity of at least 200 grams per dtex, and preferably about 270 grams per dtex to about 3,000 grams per dtex.

Non-meltable, rigid rod filaments are used in the woven substrate. By “non-meltable” it is meant in some embodiments that the filaments have a melting point of at least 250° C.; in some preferred embodiments the filaments have a melting point of at least 300° C. In some most preferred embodiments it is meant the polymer in the filaments essentially decomposes before it melts.

In some embodiments, the rigid rod filaments comprise aromatic polyamide fibers, polybenzoxazole fibers, polybenzothiazole fibers, poly{2,6-diimidazo[4,5-b4′,5′-e]pyridinylene-1,4(2,5-dihydroxy)phenylene} (PIPD) fiber, polypyridazole fibers, or mixtures thereof. Preferably, the fibers are made of para-aramid. By “aramid” is meant a polyamide wherein at least 85% of the amide (—CO—NH—) linkages are attached directly to two aromatic rings. Suitable aramid fibers are described in Man-Made Fibers—Science and Technology, Volume 2, Section titled Fiber-Forming Aromatic Polyamides, page 297, W. Black et al., Interscience Publishers, 1968. Aramid fibers are, also, disclosed in U.S. Pat. Nos. 4,172,938; 3,869,429; 3,819,587; 3,673,143; 3,354,127; and 3,094,511.

Additives can be used with the aramid and it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride or the aramid.

The preferred para-aramid is poly(p-phenylene terephthalamide) (PPD-T). By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Polybenzoxazole (PBO) and polybenzothiazole (PBZ) are suitable, such as described in WO 93/20400. Polybenzoxazole and polybenzothiazole are preferably made up of repetitive units of the following structures:

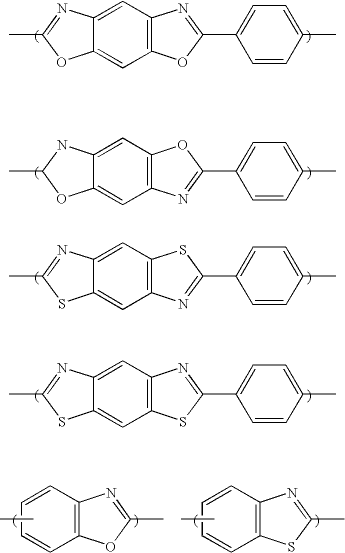

While the aromatic groups shown joined to the nitrogen atoms may be heterocyclic, they are preferably carbocyclic; and while they may be fused or unfused polycyclic systems, they are preferably single six-membered rings. While the group shown in the main chain of the bis-azoles is the preferred para-phenylene group, that group may be replaced by any divalent organic group which doesn't interfere with preparation of the polymer, or no group at all. For example, that group may be aliphatic up to twelve carbon atoms, tolylene, biphenylene, bis-phenylene ether, and the like.

The polybenzoxazole and polybenzothiazole used to make fibers of this invention should have at least 25 and preferably at least 100 repetitive units. Preparation of the polymers and spinning of those polymers is disclosed in the aforementioned International Publication WO 93/20400.

Examples of known rigid rod fibers include poly(para-phenylene terephthalate) fibers sold under the tradenames Kevlar® by E. I. du Pont de Nemours and Company and Twaron® by Teijin Fibers, poly(para-phenylene benzobisoxazole) fiber, sold under the tradename Zylon® by Toyobo, poly(benzobisthiazole), poly(2,6-diimadazo[4,5-b,4′,5′-e]pyridinylene-1,4(2,5-dihydroxy)phenylene) fiber, known under the tradename M5® by Magellan LLC.

Combinations of these rigid rod fibers can be used in the woven substrate, or minor amounts of other fibers can be combined with the non-meltable rigid rod fibers in the woven substrate as long as the resulting compressed woven substrate has densified filament bundles comprising filaments having angular cross sections caused by compression of the woven substrate.

As set forth previously, it is required that a woven substrate be compressed to achieve a fiber volume fraction in the woven substrate of at least 70%. In some more preferred embodiments the fiber volume fraction in the densified woven substrate is at least 75%; in some more preferred embodiments the densified woven substrate has a fiber volume fraction of 80% or greater. Fiber volume fraction is calculated by dividing the woven substrate basis weight by its thickness and dividing that quotient by the density of the fiber in the woven substrate. For a woven substrate with more than one (for instance, n) fiber types, fiber volume fraction can be determined by the equation:

$$( \begin{matrix}fiber volume \\ fraction\end{matrix} ) = \frac{( woven substrate areal density )}{( woven substrate thickness )} \times 100 / X$$

$$where X = {\sum }_{i = 1}^{n} {ρ}_{i} {m}_{i}$$

where i={1, 2, . . . , n} ρᵢ is the density of fiber i, and mᵢ is the ratio of the mass of fiber type i to the total fiber mass.

In some embodiments, the densified woven substrate, without the coating, has a lower permeability than the undensified woven substrate. In a preferred embodiment the densified woven substrate will have a permeability as measured by Gurley porosity of more than five times as high as the original undensified woven substrate. More preferably, the densified woven substrate will have a Gurley porosity more than ten times greater than the original undensified woven substrate.

The woven substrate, having a fiber volume fraction of at least 70% and rigid rod filaments having angular cross sections, has a coating present in an amount not more than 25% by weight of the total weight of the woven substrate and coating combined. The coating performs at least two functions. The coating allows the filaments of the densified woven substrate to remain in place with little or no movement while the coated fabric is being handled, and provides resin for adhesion of the coated fabrics together to form articles including laminates. In some embodiments the coating is present in an amount not more than 20% by weight; in some preferred embodiments the coating is present in the range of 10 to 20% by weight. Coatings severely in excess of 25% by weight, such as 40% are believed to only add weight to the coated fabric without any appreciable increase in ballistic performance; and may detract from ballistic performance.

In some embodiments the coating can be a polymer, and made be applied from a melt or solution. The type of polymer is not thought to be particularly critical as long as it adequately performs as desired; however, some polymers useful as coatings include phenolics, polyesters, vinylesters, epoxies, polyethylene, ethylene compoymers such as ethylene-vinyl acetate, ionomers, and terpolymer rubber, polypropylene, acrylates, thermoplastic diene rubbers, polyvinylbutyral, and nylon, as well as mixtures of or modifications of any of these, such as rubber phases or fire retardants. In some preferred embodiments, the coating is a blend of phenolic and toughening agents. In some preferred embodiments, the coating is selected such that it has sufficient viscosity to not appreciably penetrate the woven substrate architecture; that is, the fiber type in the woven substrate and the coating are preferably selected such that the flow of the coating into the densified woven substrate upon application is minimized.

In some embodiments the coating can be a polymerizable material, such as a monomer, an oligomer, or an uncured polymer. In this embodiment, the polymerizable coating is applied to the densified woven substrate and the coating is subsequently polymerized in place while coated on the woven substrate. As with the polymer coating, the type of polymerizable material is not thought to be critical as long as it adequately performs as desired, and any monomer, oligomer or uncured polymer that results in, for example, the previous list of polymers are useful as coatings.

While the coating can be applied to the woven substrate as a liquid, in many embodiments it is believed the coating is present substantially only on the surface of the woven substrate due to the high fiber volume fraction in the woven substrate and the angular cross sections of the filaments. In other words, it is believed the densification of the woven substrate not only packs the bundles of filaments in that layer, but also, causes the filaments to deform and better pack together without locking the filaments together. It is believed the packing of the individual filaments prevents substantial penetration of the coating between both the filaments and the filament bundles in the woven substrate. Without being constrained by theory, it is believed the increased ballistic resistance of laminates made using these coated fabrics is due to the reduction of the amount of surface area available for adhesion between the woven substrate and the coating. This reduction in surface area available for adhesion promotes adhesive failure delamination during a ballistic event. The increase in laminate ballistic resistance is more than is sacrificed by the mechanical/thermal damage to the filaments during compression in the manufacture of the coated fabric.

This invention also relates to a process of making a coated fabric comprising the steps of
(a) compressing a woven substrate containing bundles of round, non-meltable, rigid-rod filaments with heat and pressure to flatten the bundles of filaments, the bundles of filaments having a tenacity of at least 15 grams per denier (13.6 grams per dtex);
(b) continuing to compress the substrate to further deform the round cross sections of the filaments to angular cross sections and form a densified substrate having a fiber volume fraction of at least 70%; and
(c) contacting a surface of the densified substrate with a coating material.

Compression of the woven substrate to first flatten the filament bundles and then deform the cross sections can be accomplished in sequential steps on two or more compression devices, or can be accomplished on one device. In some preferred embodiments, the compression steps are accomplished in the nip of a set of calender rolls. As the woven substrate enters the nip, the filament bundles are flattened, and as the substrate travels further in the nip the filament cross sections are then deformed. It is believed that the desired 70% fiber volume fraction or higher can only be achieved if both the filament bundles are flattened and the filament cross sections are converted to angular cross sections.

In some embodiments, the woven substrate is heated prior to being compressed, or compressed between heated surfaces (e.g. rolls). In some embodiments it is preferred that this temperature be 200° C. or greater, and in some preferred embodiments the temperature is 250° C. or greater. If the filaments have a melting point above 250° C., then the substrate can be heated up to within about 20° C. of the melting point; in general the combination of heating and compression should not cause the filaments to flow and melt. In some preferred embodiments, the filaments essentially have no melt point and the polymer degrades prior to any substantial flow of the polymer in the fiber. In some embodiments, desirable densification of woven substrates of para-aramid fibers, that have a thermal decompositiont temperature of greater than 400° C., is obtained by passing the woven substrate between hard metal calender rolls heated to average temperatures above 300° C., at speeds of 6 to 12 meters/min, with a lineal pressure in the nip of greater than 500,000 N/m.

The type of apparatus or device used to densify of the woven substrate is not thought to be critical as long as the apparatus or device can densify the woven substrate to at least the point where the fiber volume fraction is at least 70% and round filament cross sections are converted to angular cross sections. Various combinations of time, temperature and pressure, and various combinations of methods of heat and pressure application, may be used to produce fiber volume fractions of 70% or greater, as desired for the final densified woven substrate to be coated.

After the woven substrate has been densified, a surface of the woven substrate is contacted with a coating. In some embodiments the coating can be a polymer, and in some embodiments the coating can be a polymerizable material, such as a monomer, an oligomer, or an uncured polymer. The coating can be applied in any fluid or film form, but generally it is applied in the form of a melt or solution. As described previously, in many embodiments the coating remains substantially on the surface of the densified woven substrate due to the high fiber volume fraction and angular cross sections of the filaments.

In one embodiment, the surface of the woven substrate is contacted with the coating by applying a liquid coating directly on the support substrate. Such coating can be applied using spreading methods known in the art such as with a rubber doctor blade or with a slit extrusion machine. The coating can then be either cooled, dried, cured, or cross-linked while in contact with the surface of the woven substrate to form a coating that forms a continuous layer on the woven substrate surface.

In another embodiment, the surface of the woven substrate is contacted with a film that becomes the coating after heat and/or pressure is applied to make the film tacky and attached to the surface of the woven substrate once the coating has cooled. This type of coating also forms a continuous layer on the woven substrate surface.

In another embodiment, the surface of the woven substrate is contacted with the coating by applying a polymerizable coating to the densified woven substrate, using such methods as disclosed for a liquid coating discussed previously. The coating is subsequently polymerized in place while present on the surface of woven substrate. In many embodiments this polymerization is achieved by the application of heat to the coating to cure, cross-link, or polymerize the coating while in contact with the surface of the woven substrate. This forms a continuous polymeric layer on the woven substrate surface.

The coated fabrics are useful in the manufacture of rigid armor, including flat and curved armor plates. Generally this is accomplished by forming laminates comprising the coated fabrics by laying up layers of the coated fabrics with the coating layers alternating with the woven substrate layers. The coated fabric layers can then be thermally bonded to form laminates using any known method, included heated presses and calenders and the like; or by applying heat to the layers and then subsequently pressing them together without additional heat.

Because the filaments in the densified woven substrate are not physically locked together, care should be taken to prevent the coated fabric from losing densification before conversion into a laminate or other end use article. For example, applying high tension to or distorting the woven substrate after densification, or the coated fabric after densification and coating, is expected to reduce woven substrate densification, and thereby reduce ballistic resistance of the end use article.

One such rigid armor application is the use of the coated fabrics in the manufacture of helmets. Such helmets are typically made by compression molding of multiple layers of coated fabric in matched metal dies. Typical ballistic resistance requirements and headborne weight constraints usually constrain the helmet to an average areal density of 5 to 12 kg/m². One example of such helmets is described in MIL-H-44099A.

Another armor application is the use of the coated fabrics in large, flat or shaped panels used for ballistic resistance. Such panels are molded under heat and pressure from multiple plies of coated fabric. Panel areal density depends on ballistic resitance requirements and weight constraints, but is often between 3 and 40 kg/M². Several examples of how such panels may be constructed are given in MIL-DTL-62474D(AT). Numerous applications can utilize multiple layers of coated fabrics pressed together into laminates; such applications include but are not limited to vehicular spall armor, vehicular armor, personal body armor, shields, shaped plates and the like.

### Test Methods

Ballistic resistance is determined by V₅₀, or the average velocity required to just perforate a given target under given conditions with a given projectile, as described in MIL-STD-662F, using the average impact velocity from three perforating and three non-perforating shots within a 40 m/s range.

Linear density of a yarn or fiber is determined by weighing a known length of the yarn or fiber based on the procedures described in ASTM D1907-97 and D885-98. Decitex or “dtex” is defined as the weight, in grams, of 10,000 meters of the yarn or fiber.

Tensile Properties. The fibers to be tested are conditioned and then tensile tested based on the procedures described in ASTM D885-98. Tenacity (breaking tenacity), elongation to break, and modulus of elasticity are determined by breaking test yarns on an Instron tester.

Areal density of the woven substrate layer is determined by measuring the weight of each single layer of selected size, e.g., 10 cm×10 cm. The areal density of the composite structure is determined by the sum of the areal densities of the individual layers.

Gurley porosity is determined by TAPPI T 460 om-02.

Woven substrate thickness is determined by ASTM D 1777.

Flexural strength and stiffness are determined by ASTM D790. Short beam shear strength is determined by ASTM D 2344. True flexural modulus and true interlaminar shear modulus are determined by a method described by [Tarnopol'skii and Kincis 1985, Chapter 5], and described in Example 4 below.

### EXAMPLES

In the following examples all parts and percentages are by weight and degrees in Celsius unless otherwise indicated. The woven substrates in Table 1 were employed in the examples and comparative examples.

TABLE 1

| Hexcel | | | | End & Pick | | Dry Basis | |
|---|---|---|---|---|---|---|---|
| Style | Yarn | | | Count | | Weight | |
| number | Type | Denier | Construction | (Yarns/in) | (yarns/cm) | (oz/yd²) | (g/m²) |
| 762 | Kevlar ® | 1410 | 2 × 2 basket | 32.5 | 12.8 | 11.8 | 396 |
| | 129 | | | | | | |
| 745 | Kevlar ® | 3000 | Plain weave | 17 | 6.7 | 13.1 | 439 |
| | 29 | | | | | | |
| 747 | Kevlar ® | 3000 | Plain weave | 10 | 3.9 | 7.6 | 255 |
| | 29 | | | | | | |
| 758 | Kevlar ® | 2820 | Plain weave | 16.3 | 6.4 | 11.8 | 396 |
| | 129 | | | | | | |

### Example 1

This example illustrates the increase in ballistic performance obtained from highly densified woven substrates having coatings. Four samples of Hexcel woven fabric style 762, designated Items 1 through 4, were densified in the nip of a calender having heated metal rolls. Additionally, a sample of the woven substrate, designated Item A, was reserved as a control and not densified by calendering. Items 1-4 were calendered in excess of 500 kN/m under a variety of temperature conditions that are given in Table 2. Percent densification was calculated for Items 1 to 4, based on their measured thickness after calendering (final woven substrate thickness) and the measured thickness of uncalendered Item A (initial woven substrate thickness), and the results are shown in Table 2.

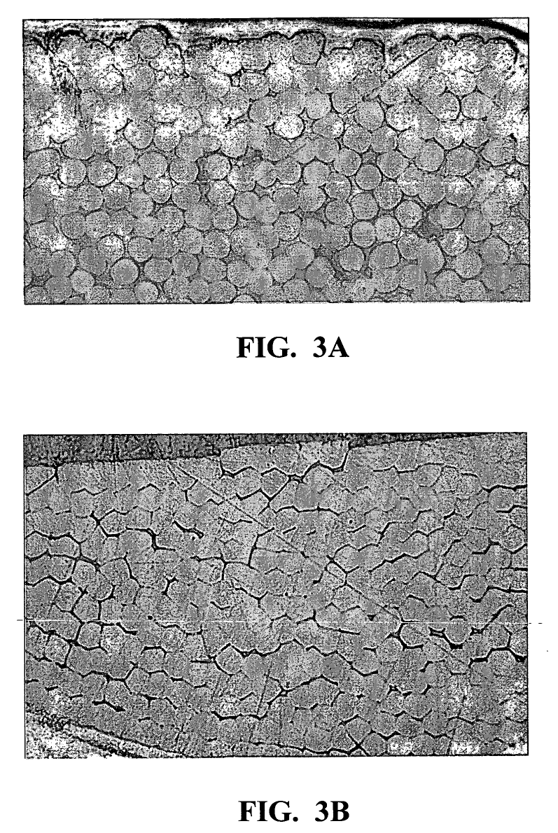

The Items were also tested for Gurley porosity, yarn break tenacity, and woven substrate tensile properties. To obtain yarn tenacity, yarns were carefully teased out of the calendered woven substrates in the fill direction, twisted to 1.1 twist multiplier, and tested. Woven substrate samples of Item A and Item 4 were also tested for the maximum force required to break a uniaxial strip having dimensions 2.5×25 cm. All of these woven substrate properties are shown in Table 3. Woven substrate samples of items A and 4 were also potted in epoxy, polished until the damage done by cutting was removed, and imaged in reflected light at 400× magnification. FIG. 3a shows a photomicrograph of a woven substrate cross section of the undensified control Item A having filaments with undeformed round cross sections, compared with FIG. 3b that shows a photomicrograph of a woven substrate cross section of the densified Item 4 having filaments with permament deformations and angular cross sections.

All of the Items were then coated on one side with 0.05 mm nominal thickness, toughened phenolic film X18906-C, from Vonroll, New Haven, Conn.; providing a coated fabric having a nominal resin content of 12±1% based on the total prepreg weight. 18 layers of each coated Items 1 through 4 and A were then laid up with warps parallel and with the coated side facing the same direction. A laminate for each of the individual Items was then made by pressing the 18 layers of the respective Items in a hot press in accordance with MIL-DTL-62474D(AT), Type 2. Two to four laminates from each Item were tested for V₅₀ against 0.22-caliber, type 2 fragment simulating projectiles per MIL-P-46593A. Panels were impacted essentially parallel to the normal of the target mid plane, at 20-25° C. and 40-65% relative humidity. Average energy absorbed was calculated from V₅₀ and nominal projectile mass. Table 3 summaries the ballistic impact results.

Table 3 reveals that calendering of the woven substrates reduced, and in some cases extremely reduced, the tensile properties of the yarns and woven substrates; however the resulting coated laminates had surprisingly increased ballistic resistance. It is thought that the reduction in mechanical properties is due to thermal degradation and the extreme deformation of the filaments during densification was overshadowed by increase in ballistic perforamance obtained by better segregation of the coating and filaments. The sealing or tightening of the woven substrate by densification both caused better packing of the filaments and because of the high pressure loadings, caused substantially round cross section filaments to take on an angular cross section; it is thought these filaments better fit together and prevented migration of the coating into the filament structure.

TABLE 2

| | | | Nip Pressure | Fiber Volume |
|---|---|---|---|---|
| Item | Fabric Style | Calender Temp (C.) | (kN/m) | Fraction |
| A | 762 | . . . | . . . | 56 |
| 1 | 762 | 340 top/175 bottom | 578 | 83 |
| 2 | 762 | 340 top & bottom | 578 | 81 |
| 3 | 762 | 365 top & bottom | 578 | 83 |
| 4 | 762 | 400 top & bottom | 578 | 85 |

TABLE 3

| | | | | Woven | Woven | | | Ballistic | |
|---|---|---|---|---|---|---|---|---|---|
| | | Extracted | Percent | substrate | substrate | | Ballistic | Resistance, | Ballistic |
| | Gurley | Fill Yarn | Change | Properties | Properties | Ballistic | Resistance, | Avg. Energy | Resistance, |
| | Porosity | Break | in Break | Ultimate | Percent | Resistance, | Percent | Absorbed at | Percent |
| Item | (s) | Force (N) | Force | Load (kN) | Change | V50 (m/s) | Increase | V50 (J) | Increase |
| A | 2.2 | 293 | . . . | 7.4 (warp) | . . . | 615 | . . . | 208 | . . . |
| | | | | 7.9 (fill) | . . . | | | | |
| 1 | 14.9 | 276 | −6 | — | — | 623 | 1.3 | 214 | 2.6 |
| 2 | 11.9 | 200 | −32 | — | — | 635 | 3.3 | 222 | 6.8 |
| 3 | 38.9 | 191 | −35 | — | — | 636 | 3.4 | 222 | 6.9 |
| 4 | 50.6 | 164 | −44 | 4.9 (warp) | −34% | 650 | 5.7 | 232 | 11.6 |
| | | | | 4.6 (fill) | −41% | | | | |

### Example 2

This example illustrates that the simple flattening of the yarn bundles in the base woven substrate to reduce the woven substrate thickness does not provide adequate increases in ballistic performance. As before, Hexcel woven fabric style 762 woven substrate was used for densification at multiple conditions, with a sample of the woven substrate, designated Item B, was not densified for a control.

Items C and D were calendered in the nip between a hard metal roll and a softer, fiber roll, to mitigate deleterious effects of pressure. The metal roll temperature was set at 200° C. to avoid thermal degradation. Item B was not calendered, Item C was passed once through the calender nip, and Item D was passed through the calender nip twice. As in Example 1, yarns were carefully teased out of the woven substrate after densification, twisted to 1.1 twist multiplier, and tested for extracted yarn break force and Gurley porosity. As an additional effort to try to improve laminate ballistic resistance without causing significant thermal degradation, Item E was densified on the equipment described in Example 1, using lower roll face temperature (175° C.). All of these woven substrates had lower woven substrate thickness after calendering, indicating the yarn bundles were flattened during calendering.

As in Example 1, the sample woven substrates were then coated on one side and 18-ply laminates were laid up, molded, and tested for V₅₀ per MIL-STD-662F. Calendering conditions, mechanical property data and ballistic data are summarized in Tables 4 and 5.

Table 5 reveals that simple flattening of the yarn bundles and reducing the thickness of the woven substrates is not sufficient to obtain increases in ballistic performance. It is believed that dramatically increased ballistic performance can only be obtained by deformation of the filaments in the woven substrate during densification.

TABLE 4

| | Initial | Final | Roll | Fiber | |
|---|---|---|---|---|---|
| | Thickness | Thickness | Temperature | Volume | Gurley |
| Sample | (mm) | (mm) | (C.) | Fraction | Porosity (s) |
| B | 0.57 | 0.57 | . . . | 48 | <1 |
| C | 0.57 | 0.52 | 200 | 53 | <1 |
| D | 0.57 | 0.52 | 200 | 53 | <1 |
| E | 0.57 | 0.44 | 175 | 62 | <1 |

TABLE 5

| | | | | Percent | | | | Ballistic | |
|---|---|---|---|---|---|---|---|---|---|
| | | Extracted | | Change | Percent | | | Resistance, | |
| | | Warp | Extracted | Warp | Change | | Ballistic | Avg. | Ballistic |
| | | Yarn | Fill Yarn | Yarn | Fill Yarn | Ballistic | Resistance, | Energy | Resistance, |
| | | Break | Break | Break | Break | Resistance, | Percent | Absorbed | Percent |
| Sample | Passes | Force (N) | Force (N) | Force | Force | V50 (m/s) | Increase | at V50 (J) | Increase |
| B | None | 294 | 289 | . . . | . . . | 646 | . . . | 230 | 0 |
| C | 1 | 252 | 239 | −14 | −17 | 638 | −1.4 | 224 | −3 |
| D | 2 | 212 | 212 | −28 | −27 | 640 | −1.0 | 226 | −2 |
| E | 1 | — | 324 | — | 11 | 618 | 0.6 | 211 | 1 |

### Example 3

Samples of a tightly-woven woven substrate style (Hexcel style 745) and an open or loosely-woven woven substrate style (Hexcel style 747) were densified using the same equipment and conditions as Example 1. Physical property data for undensified control (Items F-H) and densified (Items 5-7) woven substrates before coating are shown in Table 6. The woven substrate samples were then coated on one side with toughened phenolic film as in Example 1, with the exception the nominal resin content was 11±2% based on the total prepreg weight. Laminates of the coated woven substrates were then laid up warps parallel and with the resin coating all facing the same direction, and molded in a hot press in accordance with MIL-DTL-62474D(AT), except that half the panels were molded at 3.4 Bar and the other half were molded at 34 Bar. Laminated panels were tested for V₅₀ per MIL-STD-662F, using three pairs in a 40 m/s range, against 0.30-caliber fragment simulating projectiles per MIL-P-46593A, and two grain (0.130 gram) right circular steel cylinders, with a nominal hardness of Rc 30±2 and nominal strike face area Aₚ of 0.0625 cm². This gives a range of 0.14<AD Aₚ/mₚ<0.42, where AD is target areal density and mₚ is projectile mass. This range of ratios of fragment simulating projectile size to laminate thickness is of interest in body armor.

Two laminates from each combination of woven substrate style, densification condition (densified versus control), and projectile type were tested. The laminates were impacted essentially parallel to the normal of the target mid plane, at 20-25° C. and 40-65% relative humidity. Average energy absorbed was calculated from V₅₀ and nominal projectile mass. Averaged results are given in Table 7. Woven substrates of this invention had higher densification (>75% of fiber density) and increased Gurley porosity compared to the control woven substrates. Molded laminates of this invention had consistently higher ballistic resistance, for the range of woven substrate cover factors, molding pressures pressure and projectiles chosen.

TABLE 6

| | | | | | Initial | |
|---|---|---|---|---|---|---|
| | Hexcel | Initial | Final | Fiber | Gurley | Increase |
| | Fabric | Thickness | Thickness | Volume | Porosity | in Gurley |
| Sample | Style | (mm) | (mm) | Fraction | (s) | Porosity |
| F | 747 | 0.36 | . . . | 49 | <1 | . . . |
| 5 | 747 | 0.36 | 0.22 | 80 | 5.5 | >5.5 X |
| G | 747 | 0.36 | . . . | 49 | <1 | . . . |
| 6 | 747 | 0.36 | 0.22 | 80 | 5.5 | >5.5 X |
| H | 745 | 0.59 | . . . | 52 | 7 | . . . |
| 7 | 745 | 0.59 | 0.41 | 75 | 18.9 | 2.7 X |

TABLE 7

| | Percent | | | | | Ballistic | Ballistic | Ballistic |
|---|---|---|---|---|---|---|---|---|
| | Coating | No. of | Molding | | Ballistic | Resistance | Resistance | Resistance |
| | by | Plies in | Pressure | | Resistance | Percent | Avg. Energy | Percent |
| Sample | Weight | Laminate | (bar) | Threat | V50 (m/s) | Increase | Absorbed (J) | Increase |
| F | 13 | 30 | 3.4 | 0.30-Caliber Fragment | 495 | . . . | 349 | . . . |
| 5 | 13 | 30 | 3.4 | 0.30-Caliber Fragment | 524 | 5.9 | 391 | 12 |
| G | 13 | 30 | 34 | 0.30-Caliber Fragment | 443 | . . . | 279 | . . . |
| 6 | 13 | 30 | 34 | 0.30-Caliber Fragment | 491 | 10.9 | 343 | 23 |
| H | 9 | 18 | 34 | 0.30-Caliber Fragment | 533 | . . . | 405 | . . . |
| 7 | 9 | 18 | 34 | 0.30-Caliber Fragment | 542 | 1.7 | 419 | 3 |
| F | 13 | 30 | 3.4 | 2 Grain RCC | 1002 | . . . | 65 | . . . |
| 5 | 13 | 30 | 3.4 | 2 Grain RCC | 1059 | 5.7 | 73 | 11.8 |
| G | 13 | 30 | 34 | 2 Grain RCC | 972 | . . . | 61 | . . . |
| 6 | 13 | 30 | 34 | 2 Grain RCC | 1000 | 2.8 | 65 | 5.7 |
| H | 9 | 18 | 34 | 2 Grain RCC | 1003 | . . . | 65 | . . . |
| 7 | 9 | 18 | 34 | 2 Grain RCC | 1021 | 1.8 | 68 | 3.6 |

### Example 4

30-ply laminates of coated Style 747 fabric, both control and densified, were made as in Example 3 with 13% coating by weight except they were molded per MIL-DTL-62474D, type 2 (non-autoclave) at a pressure of 13.6 bar. They were machined with a water jet. Specimens were tested for flexural stiffness in three-point bend per ASTM D 790, at aspect ratios of 8,16 and 54, flexural strength per ASTM D790 at aspect ratios of 8 and 16, and short beam shear stiffness per ASTM D 2344, at an aspect ratio of 4. Six to ten replicates were performed for each test, aspect ratio and material. True flexural modulus and true interlaminar shear modulus were determined from measured, apparent stiffnesses by the method presented in [Tarnopol'skii and Kincis 1985, Chapter 5]: ASTM D790 and ASTM D 2344 results are plotted in the coordinates (flexural stiffness)⁻¹ versus (aspect ratio)⁻², and fitted to a linear regression. True flexural modulus is the reciprocal of the intercept of the regression, and true interlaminar shear modulus is 1.2 divided by the slope of the regression.

Table 8 lists average values of the laminate mechanical properties. Surprisingly, the invention has higher flexural strength, true flexural modulus, and true interlaminar shear modulus, all of which are desirable for a stronger, more durable article. This contradicts the literature on fabric-reinforced armor laminates [Lastnik et al 1984, Harpell et al 1986, Vasudev & Mehlman 1987, Arndt & Coltman 1990], which have consistently found that laminate ballistic resistance increases when these properties decrease. Therefore, this invention provides an opportunity to simultaneously improve both ballistic resistance and structural integrity of rigid armor articles, something not anticipated in the prior art.

The invention is also thinner, which is desirable for a less bulky part.

Note that panel bending stiffness is proportional to (true flexural modulus)×(panel thickness)³. Since this invention will result in a more dense, thinner article under similar molding conditions compared to conventional, undensified reinforcements, it is desirable that the invention increase the true flexural modulus such that the reduction in thickness does not lead to lower panel bending stiffness. As seen in Table 8, panel bending stiffness is increased by the invention compared to the control.

TABLE 8

| | | | Flexural | Flexural | True | Interlaminar | Percent |
|---|---|---|---|---|---|---|---|
| | Fiber | | Strength | Strength | Flexural | Shear | Improvement |
| | Volume | Thickness | (8:1) | (16:1) | Modulus | Modulus | In Bending |
| Sample | Fraction | (mm) | (MPa) | (MPa) | (GPa) | (MPa) | Stiffness |
| Control | 49 | 7.0 | 24.1 | 27.3 | 8.1 | 23.6 | . . . |
| Densified | 80 | 6.2 | 32.0 | 31.8 | 17.2 | 73.0 | 54 |

### Example 5

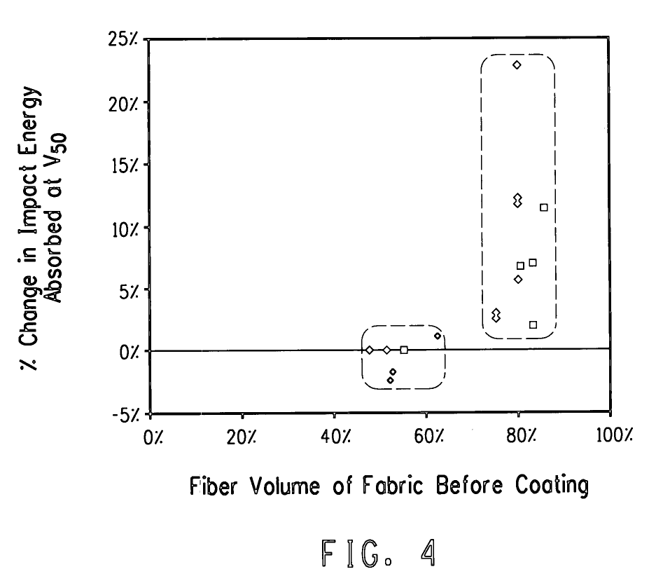

FIG. 4 is a plot of percent change relative to the control of the average energy absorbed at V₅₀ versus fiber volume fraction prior to resin coating for all densified materials Examples 1 through 3. Given the fact that the examples involve different reinforcements with different expected performance, tested with different projectiles, there was scatter in the plot. However, the results still fall into two regimes. Fiber volume fractions below 70% appeared to show no consistent improvement in laminate ballistic resistance. Fiber volume fractions of at least 70% of the fiber density appeared to show consistent improvement in laminate ballistic resistance with improvement increasing as densification and compaction calender temperature increased.

What is claimed is:

1. A coated fabric suitable for reinforcing rigid articles to protect against ballistic impact comprising:
a) a woven substrate having a fiber volume fraction of at least 70%, the fiber being present as densified filament bundles comprising non-meltable, rigid-rod filaments, the filament bundles having a tenacity of at least 15 grams per denier (13.6 grams per dtex), the filaments having angular cross sections, and
b) a coating on the woven substrate present in an amount not more than 25% by weight of the total weight of the woven substrate and coating combined.

2. The coated fabric of claim 1 wherein the woven substrate has a fiber volume fraction is at least 75%.

3. The coated fabric of claim 1 wherein the coating comprises not more than 25% by weight of the total weight of the woven substrate and coating combined.

4. The coated fabric of claim 2 wherein the coating comprises not more than 20% by weight of the total weight of the woven substrate and coating combined.

5. The coated fabric of claim 1 wherein the coating is a polymer coating.

6. The coated fabric of claim 1 wherein the coating is an monomer, oligomer, or uncured polymer.

7. The coated fabric of claim 1 wherein the Gurley porosity of the woven substrate with densified filament bundles of filaments having angular cross sections, without the coating, is at least five times the same weight of a woven substrate having undensified filament bundles of filaments having round cross sections.

8. The coated fabric of claim 1 wherein the non-meltable rigid rod fibers are selected from the group consisting of poly(para-phenylene terephthalate), poly(para-phenylene benzobisoxazole), poly(benzobisthiazole), poly{2,6-diimadazo[4,5-b,4′,5′-e]pyridinylene-1,4(2,5-dihydroxy)phenylene} and copolymers and mixtures thereof.

9. A laminate containing at least two layers of the coated fabric of claim 1.

10. An article reinforced with the coated fabric of claim 1.

11. The article of claim 10, selected from the group of helmet, vehicle armor spall protector,ceramic-faced armor backing, vehicle armor, and riot shield.

12. A process of making a coated fabric comprising the steps of
(a) compressing a woven substrate containing bundles of round, non-meltable, rigid-rod filaments with heat and pressure to flatten the bundles of filaments, the filament bundles having a tenacity of at least 15 grams per denier (13.6 grams per dtex);
(b) continuing to compress the substrate to further deform the round cross sections of the filaments to angular cross sections and form a densified substrate having a fiber volume fraction of at least 70%; and
(c) contacting a surface of the densified substrate with a coating material.

13. The process of claim 12 further comprising the step of curing or polymerizing the coating material on the densified substrate.

14. The process of claim 12 wherein compressing the woven substrate is accomplished by calendering the substrate in a nip between two rolls.

15. The process of claim 14 further comprising the application of heat to the woven substrate either before or during calendering.

16. The process of claim 12 wherein the coating material is a polymer, a monomer, an oligomer, or uncured polymer.

17. The process of claim 12 wherein the substrate is compressed until a densified substrate having a fiber volume fraction of at least 75% is formed.

18. The process of claim 12 wherein the non-meltable rigid rod fibers are selected from the group consisting of (para-phenylene terephthalate), poly(para-phenylene benzobisoxazole), poly(benzobisthiazole), poly{2,6-diimadazo[4,5-b,4′,5′-e]pyridinylene-1,4(2,5-dihydroxy), phenylene} and copolymers thereof.
